(19) United States
(12) Patent Application Publication
(10) Pub. No.: US 2026/0051250 A1
(43) Pub. Date: Feb. 19, 2026

(54) SYSTEM

(71) Applicant: SOFTBANK GROUP CORP., Tokyo (JP)

(72) Inventor: Tetsuo FURUKAWA, Tokyo (JP)

(73) Assignee: SOFTBANK GROUP CORP., Tokyo (JP)

(21) Appl. No.: 19/302,228

(22) Filed: Aug. 18, 2025

(30) Foreign Application Priority Data
Aug. 19, 2024 (JP) 2024-138108

(51) Int. Cl. G08G 1/16; G06V 20/58; G07C 5/02

(52) U.S. Cl. CPC G08G 1/16; G06V 20/58; G07C 5/02

(57) ABSTRACT

A system includes a processor that acquires image data by an image acquisition unit fixed to a driving apparatus, analyzes the acquired image data, issues an alert to a driver based on the analyzed data, and automatically records and saves data in the event of an accident.

### CROSS-REFERENCE TO RELATED APPLICATION

This application is based on and claims priority under 35 USC 119 from Japanese Patent Application No. 2024-138108 filed on Aug. 19, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, the use of electric kickboards and other personal mobility devices has increased rapidly. However, there are significant safety concerns due to the limited protection offered by such vehicles, as well as the increasing frequency of accidents involving pedestrians, vehicles, and obstacles. Conventional systems do not provide adequate real-time risk assessment or timely alerting to drivers, nor do they efficiently record and preserve evidence in the event of an accident. There is therefore a need for a comprehensive system that can continuously detect collision risks, proactively alert users, and automatically save relevant data when an incident occurs.

### SUMMARY

The invention solves these problems by providing a system comprising a processor that acquires image data from an image acquisition unit fixed to a driving apparatus, analyzes the acquired image data, issues alerts to the driver based on the analyzed results, and, in the event of an accident, automatically records and saves data. The system may further include a mobile terminal as the image acquisition unit and implement AI models to evaluate distances to vehicles, persons, and objects, thereby enabling accurate risk assessment and prompt warning, as well as providing secure storage of accident-related data for future reference.

“Processor” means a hardware component, such as a microprocessor or central processing unit (CPU), which executes instructions to perform data processing and system control functions within the system.

“Image acquisition unit” means a device or module capable of capturing visual image data, such as a camera or imaging sensor, which is fixed to a driving apparatus to obtain real-time video or still images of the surroundings.

“Driving apparatus” means a vehicle or personal mobility device, such as an electric kickboard, to which the image acquisition unit is fixed for the purpose of transportation.

“Image data” means digital information representing captured visual scenes, including video frames or still images, obtained by the image acquisition unit.

“Analyzes” means performing processing on the acquired image data to extract information, such as identifying objects, measuring distances, or assessing risks, by using algorithms or models implemented on the processor.

“Alert” means a warning or notification, which may be visual, audible, or tactile, provided to a driver to indicate a potential risk or abnormal condition.

“Driver” means a person who operates or controls the driving apparatus.

“Automatically records” means initiating the storage of data, such as video footage and sensor readings, without manual intervention upon detection of an accident or predefined event.

“Accident” means an unexpected incident or event involving the driving apparatus, such as a collision or impact, which may cause injury or damage.

“Saves data” means storing relevant information, including recorded images and associated incident details, in a memory or storage medium for later retrieval or analysis.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

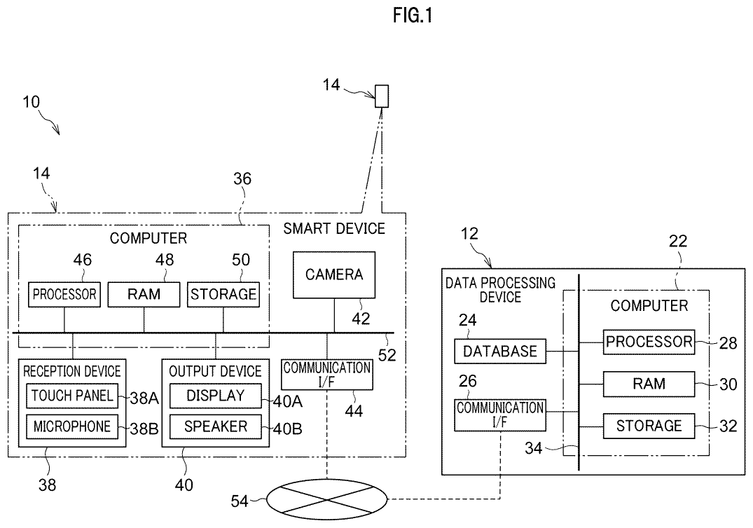

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

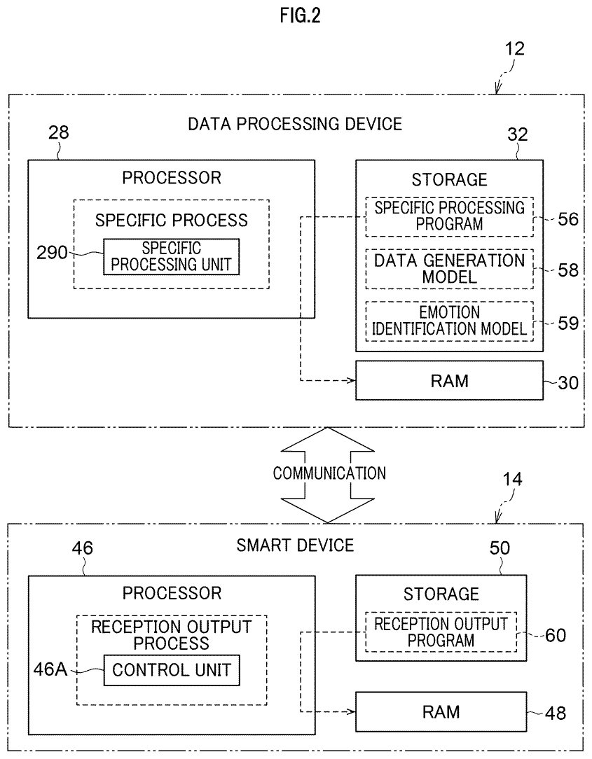

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional transportation apparatuses, it is difficult for users to recognize and respond in real time to risks, such as the presence of pedestrians or obstacles, while operating the apparatus. Furthermore, in the event of an accident, it is often not possible to automatically and reliably record objective evidence, such as environmental video or impact data, in a manner suitable for subsequent insurance or legal procedures. As a result, drivers may face increased safety hazards and significant complications in post-accident processing.

The specific processing by the specific processing unit 290 of the data processing device 12 in Example 1 is realized by the following means.

The present invention provides a server comprising a processor configured to receive environmental and operational information acquired by an information acquisition unit mounted on a transportation apparatus, analyze such information using an artificial intelligence model for object identification and distance computation, evaluate contact risk, generate and transmit alert signals when necessary, and automatically record, transmit, and store video data and related operational information upon detection of impact events. This enables real-time risk assessment and user notification, as well as automatic incident recording and secure storage of evidence for insurance or legal use.

The term “processor” refers to an electronic circuit or computing device capable of executing instructions to perform data processing tasks as configured by a program.

The term “information acquisition unit” refers to any hardware component or assembly, such as a sensor, camera, or communication device, that obtains environmental and operational data from a transportation apparatus.

The term “transportation apparatus” refers to a vehicle or device used for moving people or goods, including but not limited to personal mobility vehicles, bicycles, or scooters.

The term “image information” refers to digital data representing visual scenes captured from the surroundings of the transportation apparatus.

The term “operation information” refers to data related to the state, position, speed, acceleration, or other parameters indicating the movement or status of the transportation apparatus.

The term “communication network” refers to any system or infrastructure enabling the wireless or wired transmission of data between a terminal and an external device.

The term “external processing device” refers to a computing system or server located outside the transportation apparatus that receives transmitted information and executes high-level data analysis and processing tasks.

The term “artificial intelligence-based analysis unit” refers to software or hardware implementing algorithms, such as neural networks or machine learning models, for the purpose of interpreting, analyzing, or classifying data including images and operational parameters.

The term “deep learning model” refers to a subset of artificial intelligence-based algorithms that utilize multiple layers of interconnected nodes to analyze complex data patterns, particularly for object detection and distance estimation.

The term “risk determination unit” refers to logic or algorithms that evaluate the likelihood or severity of potential contact or collision events based on analysis results and operational data. The term “alert signal” refers to a notification or command generated by the system to warn a user of a high-risk situation, generally based on a predefined threshold.

The term “notification” refers to the communication of information to the user by means of visual, auditory, or tactile outputs, designed to prompt a response to a detected risk.

The term “impact information” refers to data indicating a physical shock or collision detected by a sensor associated with the transportation apparatus.

The term “automatic recording process” refers to a procedure by which the system autonomously initiates the capture and storage of data, such as video or operational logs, in response to detected impact information.

The term “external storage area” refers to any data storage facility, such as cloud storage or network-attached storage, that is physically or logically separate from the transportation apparatus and is used to preserve recorded data for subsequent retrieval.

### Embodiment for Implementing the Invention

In order to realize the present invention, the system is constructed by combining a transportation apparatus, a terminal device, an external server (or processing device), and a communication network that enables real-time data transmission and reception. The following describes representative hardware and software used for each component of the system, concrete operation methods, and an example scenario illustrating the use of the invention.

The terminal, such as a mobile device mounted on a transportation apparatus (for example, an electric scooter or bicycle), is equipped with a camera, a location sensor (such as a GPS module), an accelerometer, and a communication module (such as 4G, 5G, or Wi-Fi). Commercially available smartphones (for example, with an operating system such as Android or iOS) may be used as the terminal. The terminal executes a dedicated safety monitoring application, which controls the sensors, collects environmental and operational information (such as video data, position data, speed, and acceleration), and manages network communications.

The terminal continuously captures image information using the camera and periodically gathers operation information from the sensors. This information is bundled into data packets and transmitted in real time to the server over a secure network connection. The server, which may be implemented on a general-purpose computer or a cloud-based computing resource, includes a processor for high-speed data processing, volatile or non-volatile memory, and access to external storage (such as networked disk drives or cloud storage services).

The server receives data packets from the terminal and temporarily stores them for processing. Analysis of the received data is performed by an artificial intelligence-based analysis unit, which may be implemented using a deep learning framework such as TensorFlow. The AI model identifies target objects (such as pedestrians, vehicles, and other obstacles) in the image information, estimates the distance from the transportation apparatus to these objects through computer vision algorithms, and evaluates potential risks using a risk determination logic.

If the evaluated risk, based on position, speed, and proximity to the detected object, exceeds a pre-set threshold, the server generates an alert signal and transmits it back to the terminal. The terminal uses its display, speaker, and vibration motor to communicate warnings to the user by visual, auditory, or tactile means. In the event of detecting an impact based on acceleration or shock sensor data, the terminal immediately enters an automatic recording mode, saving a buffer of video data captured both before and after the incident. This recorded data, along with related operational information, is sent to the server and stored securely in an external storage area, such as a cloud storage service. Providers of such storage may include, but are not limited to, general-purpose cloud service vendors.

As an example, when a user rides an electric scooter with a smartphone running the dedicated application, the terminal sends environmental and operational data to the server continuously. If the server detects that a pedestrian is dangerously close ahead, it sends an alert back so the terminal can immediately display a red warning and play an audio message. Upon collision or sudden impact, the terminal automatically records recent and subsequent footage and uploads it for secure storage, allowing insurance companies or authorized parties to access the incident data later if needed.

The system may be configured, maintained, and further optimized using generative AI models to tailor hazard detection and alert strategies. The following prompt sentence can be used when consulting a generative AI model for further development and improvement of the system: “I want to implement a real-time safety monitoring system for electric kickboards. The system must collect environmental and motion data on a smartphone, transmit it to a server for AI-based analysis, alert the rider of risks, and automatically record and store video when an accident is detected. How should I design the data transmission flow, AI processing steps, and accident data storage using technology such as TensorFlow and cloud storage?”

This embodiment clarifies how the invention may be implemented using currently available hardware, artificial intelligence software, and cloud computing resources.

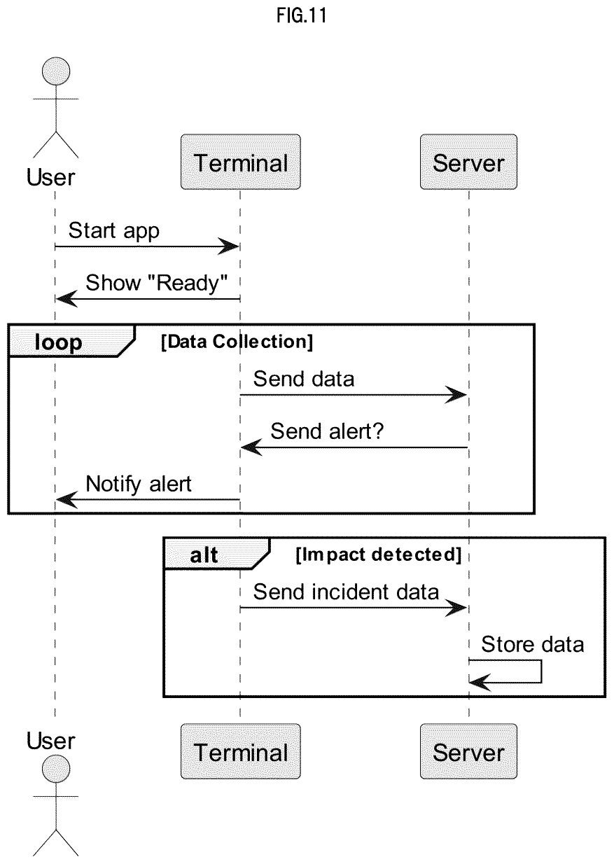

The following describes the processing flow using FIG. 11.

### Step 1:

The user mounts the terminal, such as a smartphone, onto a transportation apparatus and launches the dedicated safety monitoring application.

Input: Transportation apparatus and smartphone in an inactive state; user action to start the application.

Output: The terminal is activated and displays a “system ready” message to the user.

The terminal initializes the camera, GPS sensor, accelerometer, and establishes a network connection.

### Step 2:

The terminal continuously acquires environmental and operational data.

Input: Real-time camera feed, GPS location, speed, and acceleration information from onboard sensors.

The terminal packages image frames with time-stamped operational data at regular intervals (such as every 0.5 seconds).

Output: Data packets consisting of video frames, GPS coordinates, and acceleration/speed values.

The terminal prepares these data packets for secure network transmission.

### Step 3:

The terminal transmits the data packets to the server via the communication network.

Input: Prepared data packets containing visual and operational information.

Output: Data packets sent over the network to the server.

The terminal uses secure protocols (such as HTTPS) and monitors network status to ensure reliable delivery.

### Step 4:

The server receives incoming data packets from the terminal and performs data integrity checks.

Input: Received data packets from the terminal.

Output: Validated and decoded image and operational data stored in server memory for further analysis.

The server verifies that packets are complete and requests retransmission if any data is missing or corrupted.

### Step 5:

The server analyzes the received data using an artificial intelligence model.

Input: Image information and operational data (such as location and speed) from validated packets.

The server applies a deep learning model (implemented using software such as TensorFlow) to detect target objects (pedestrians, vehicles, obstacles) and estimate distances from the transportation apparatus.

Output: Analysis results including object types, positions, and distance calculations for each scene.

The server stores these intermediate results for risk assessment.

### Step 6:

The server evaluates the contact risk using a risk determination algorithm.

Input: Analysis results from the AI model and operational data (such as current speed and relative positions).

The server calculates a risk score for each detected object by combining distance, speed, and direction data. If any risk score exceeds a predefined threshold, the server generates and logs an alert signal.

Output: Risk evaluation results and, if needed, a generated alert signal intended for the user.

### Step 7:

The server transmits the alert signal to the terminal when a dangerous situation is detected.

Input: Generated alert signals and related scene information.

Output: Alert messages sent to the terminal over the network.

The server tags each alert with context (e.g., “pedestrian ahead,” “object detected left side”) and transmits this information with minimum latency.

### Step 8:

The terminal receives the alert message and notifies the user through multiple channels.

Input: Alert message and context from the server.

The terminal displays a visual warning on the screen, plays an audible warning through the speaker, and triggers vibration when urgency is high.

Output: User notification in visual, auditory, and/or tactile form.

The user is immediately made aware of the risk and can take preventive action, such as reducing speed or changing path.

### Step 9:

The terminal constantly monitors the shock sensor to detect possible collisions.

Input: Live accelerometer data.

If a sudden impact is detected above the set threshold, the terminal enters automatic recording mode, saving buffered video from several seconds before and after the event.

Output: Video and operational data associated with the impact event are packaged for transmission.

### Step 10:

The terminal transmits incident-related data to the server for storage.

Input: Video footage and operational data buffered around the time of the detected impact.

Output: Incident data transmitted to the server for permanent storage.

The terminal prioritizes this data transmission and confirms data upload completion.

### Step 11:

The server receives the incident data and securely stores it on an external storage area, such as a cloud storage service.

Input: Received incident video and operational data from the terminal.

Output: Incident record securely stored and retrievable by authorized entities, such as insurance or legal representatives.

The server indexes the stored incidents by time, device ID, and GPS location for efficient retrieval and future use.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional safety management systems for vehicles, it is difficult to accurately and efficiently monitor the surrounding environment, assess collision risks in real time, and consider the operator's emotional state for adaptive alerting. Existing systems may not provide timely or appropriate warnings, and recorded data may not capture the critical moments before and after an accident. Furthermore, current systems generally do not integrate real-time analysis of multi-modal data, such as environmental, physical, and emotional information, to optimize safety measures.

The specific processing by the specific processing unit 290 of the data processing device 12 in Application Example 1 is realized by the following means.

The present invention provides a server comprising a processor configured to acquire image and physical information from an image information acquisition device installed on a vehicle, analyze the information in real time using a generative information processing model, estimate collision risk and operator emotional state, deliver adaptive alerts to the operator based on the combined analysis, and record relevant information dynamically to a memory device in response to specific events. This enables comprehensive and context-aware safety management by combining multi-modal real-time data analysis, adaptive risk alerting, and event-driven data preservation.

The term “image information acquisition device” refers to a generic hardware apparatus installed on a vehicle, such as a camera or sensor, that captures visual or image-based data regarding the vehicle's surroundings or interior.

The term “physical information” refers to data representing measurable physical parameters associated with the vehicle, such as speed, acceleration, distance to objects, impact force, or spatial orientation.

The term “information analysis apparatus” refers to a processing unit, including a processor and associated memory, that is configured to analyze acquired image information and physical information using software algorithms or artificial intelligence models.

The term “collision risk assessment” refers to an evaluation output by the processor that indicates the likelihood of the vehicle coming into contact with another object, person, or vehicle based on current sensor and image data.

The term “operator emotional state” refers to the mental or psychological condition of the operator of the vehicle, estimated by analyzing visual and/or audio data, including but not limited to indicators of stress, distraction, or attention.

The term “alert control apparatus” refers to a functional component comprising hardware and/or software that generates and delivers notifications, warnings, or alerts to the operator in various forms such as visual, audio, or haptic feedback.

The term “memory device” refers to a general-purpose or dedicated storage unit that retains data, including recorded images and sensor information, particularly in connection with pre-defined events such as collisions or sudden impacts.

The term “generative information processing model” refers to a system or software, such as a neural network or artificial intelligence algorithm, that is trained to process and synthesize complex data from multiple sources, enabling simultaneous analysis of images, physical measurements, and emotional states.

The term “computational resources” refers to the hardware and software components necessary for the execution of intensive data processing tasks, including but not limited to central processing units, graphics processing units, and memory modules.

The term “adaptive information provisioning” refers to the process of delivering personalized and context-dependent messages, alerts, or notifications to the operator, the content of which is determined by the combined analysis of environmental, physical, and emotional information.

The embodiments for implementing the invention will now be described in detail. A system according to the present invention consists of a processor that coordinates the functions of a terminal (such as a smartphone or an embedded computing unit), a server (remote or cloud-based computational resource), and a plurality of sensing hardware attached to a vehicle (for example, an electric kickboard, car, or other mobile platform).

The terminal is fixed to the vehicle and equipped with one or more image information acquisition devices, such as cameras (including wide-angle or 360-degree cameras), as well as physical sensors such as accelerometers, gyroscopes, distance sensors, speed sensors, and microphones. As specific examples, smartphones with integrated sensors or dedicated sensor modules may be used. The terminal also includes wireless communication modules (for example, Wi-Fi or mobile connectivity) for data transmission.

When the system is initiated by the user, the terminal begins to capture real-time image information from its camera and physical data from its sensors. The terminal further uses a front-facing camera and microphone to continuously acquire data related to the operator's face and voice as sources for emotion state analysis.

The terminal generates data packets comprising the above-mentioned image information, physical sensor measurements, and user-related data, and transmits these data packets periodically to the server by a secure communication protocol (such as HTTPS).

The server receives these data packets and conducts multi-modal analysis. Specifically, the server uses an AI-based information processing model implemented, for example, with software environments such as TensorFlow, Keras, or PyTorch, to analyze the image data and sensor data. The server employs video processing software such as OpenCV to assist in preprocessing imagery, detecting objects, and estimating spatial relationships. The system further utilizes emotion analysis models, which may be developed with neural network libraries or API services for facial expression recognition and voice emotion detection.

Based on this multi-modal analysis, the server assesses collision risk (for example, by calculating spatial distances to detected objects and pedestrians and considering velocity and trajectory data) and infers the operator's emotional state (such as “attentive,” “distracted,” or “stressed”). The server then determines the appropriate alert type and alert strength to deliver, adaptively combining risk and emotional condition. For alert notification, various modules on the terminal are triggered, such as visual warnings on the device display, audio messages via speakers, or haptic feedback using vibration modules.

In the event that the terminal detects a significant physical impact (using data from the accelerometer or shock sensor), the system automatically enters an event mode, and the terminal records and preserves relevant video and sensor data—including timestamps before and after the event—and transmits these recordings to the server. The server saves these records in a secure memory device or cloud storage service (for example, cloud object storage from a general-purpose provider).

Additional functions may allow the user to submit a post-event report or further details via the mobile application interface, associating this data with the recorded event information.

In this way, the system enables comprehensive, adaptive, and context-aware safety management for a mobile platform. The relationship and processing between the terminal, server, and user ensure that data acquisition, analysis, adaptive alerting, and event-driven information preservation are robustly integrated.

### Concrete Example

For instance, while a user operates an electric mobility device, the terminal captures live video and sensor data. When the server detects, using a generative AI model, that a pedestrian is less than 1.5 meters ahead and the user's emotional state is anxious or distracted, the server sends an alert with increased intensity to the terminal. The terminal then provides a strong visual and audio warning, prompting the user to slow down and avoid danger. If an accident occurs, the system automatically records and uploads the pre- and post-event footage and sensor readings to cloud storage for subsequent review.

Example prompt sentences for a generative AI model:

“Create an AI model that evaluates collision risk from real-time video data and provides operator alerts, adjusting warning strength based on detected emotional state.”

“Develop a program to automatically record and upload pre- and post-accident video data to the cloud upon impact detection using vehicle-mounted sensors.”

“Design a driver monitoring system that adapts frequency and strength of alerts in real time based on operator emotion analyzed from face and voice data.”

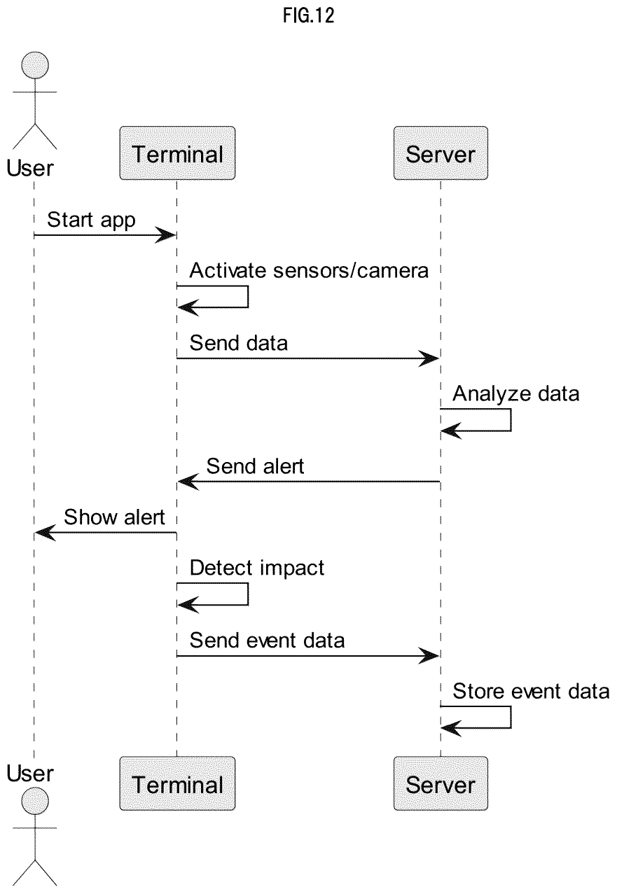

The following describes the processing flow using FIG. 12.

### Step 1:

User attaches a terminal, such as a smartphone, to the vehicle and launches the safety monitoring application. The input for this step is the physical action of connecting the terminal and opening the application. The output is the activation of the application and readiness of the terminal for sensor and video capture. The user follows instructions on the device screen and confirms necessary permissions for camera, microphone, and sensors.

### Step 2:

Terminal activates the image information acquisition device (camera), physical sensors (accelerometer, gyroscope, speed and distance sensors), and the microphone. The input for this step is the initialization command from the application. The output is the continuous acquisition of image frames, sensor readings, and audio data. The terminal starts capturing video of the vehicle's environment, measuring speed and distance, and recording snippets of the operator's voice.

### Step 3:

Terminal periodically collects and packages the most recent image frames, physical sensor data, and face/voice data into a data packet. The input is the raw sensor and image/audio data streams. The terminal performs initial preprocessing, such as normalizing image size, cleaning noisy sensor readings, and compressing audio data. The output is a formatted and encrypted data packet ready for transmission.

### Step 4:

Terminal transmits the data packet to the server via a secure wireless communication channel such as HTTPS. The input is the encrypted data packet from the previous step. The output is the successful sending of sensor, image, and audio data to the remote server for further analysis.

### Step 5:

Server receives the incoming data packet and stores it in a temporary buffer or database, indexing the data with identifiers such as session ID and timestamp. The input is the transmitted data packet. The output is organized, session-based records of incoming environmental and operator data.

### Step 6:

Server processes the received image frames and sensor readings using a generative AI model and video processing software. The input is the session data (image, physical, and audio information) stored in the database. The server executes object detection, spatial distance estimation (such as the proximity of pedestrians or vehicles), and calculates collision risk. The output is a risk assessment score for each time segment and a list of detected objects.

### Step 7:

Server analyzes the received face and voice data using an emotion recognition model. The input is the processed face images and audio segments. The server extracts emotional features such as facial expression metrics and voice stress indicators, and classifies the operator's emotional state (for example, attentive, distracted, or stressed). The output is a real-time emotional state label for the operator.

### Step 8:

Server combines the risk assessment and emotional state analysis. Based on predefined logic, the server decides whether to generate an alert, and if so, determines the alert's type and intensity. The inputs are the risk score and the emotional state label. The server runs an algorithm to match certain risk/emotion combinations to alert parameters. The output is an alert signal containing alert type (visual, audio, haptic), instructions, and strength setting.

### Step 9:

Server transmits the alert signal to the terminal. The input is the generated alert message. The output is the delivery of the alert signal via the data channel to the terminal.

### Step 10:

Terminal receives the alert signal and executes the corresponding warning behavior. The input is the alert signal from the server. The terminal triggers the display module (showing warning text or symbols), speaker module (playing a warning sound), and/or vibration module (initiating haptic feedback) based on the alert instructions. The output is a multi-modal alert that notifies the user in real time.

### Step 11:

User perceives the alert and takes an appropriate reaction, such as slowing down or stopping the vehicle. The input is the warning issued on the terminal. The output is the user's behavioral adjustment intended to prevent a potential accident.

### Step 12:

Terminal continuously monitors accelerometer and shock sensor data for abrupt impacts. When an impact above a threshold is detected, the terminal activates event mode and begins saving video and sensor data from a pre-defined period before and after the event. The input is real-time sensor and image data. The terminal processes a rolling buffer of pre-impact data and starts new post-impact logging. The output is a collection of event-specific image and sensor data.

### Step 13:

Terminal securely transmits the recorded event data to the server. The input is the collected footage and sensor readings from the event window. The output is the successful upload of crash-related data to the server.

### Step 14:

Server receives the event data and archives it in a secure storage device or cloud service, where it is indexed and made retrievable for insurance or legal review. The input is the uploaded event data. The server stores, manages, and documents the data for subsequent investigation or claims processing. The output is safely preserved accident-related evidence with appropriate metadata.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional safety systems for driving apparatuses, such as electric kickboards or similar vehicles, evaluate physical risks based only on environmental information. These systems do not consider the real-time emotional state or attention level of the user, resulting in insufficient warning or intervention in high-risk situations where stress or inattentiveness is a factor. Furthermore, such conventional systems lack reliable automated accident data recording and secure storage mechanisms, making it difficult to retain necessary evidence for insurance or legal procedures. Consequently, there is a need for a safety system capable of detecting potential risks by simultaneously analyzing environmental information and user emotional state, delivering adaptive alerts, and securely preserving important evidence in the event of an accident.

The specific processing by the specific processing unit 290 of the data processing device 12 in Example 2 is realized by the following means.

The present invention provides a server comprising a processor configured to acquire various types of information related to the surrounding environment with an information acquisition unit fixed to a driving apparatus, analyze the acquired data including object distance, velocity, and user emotional state using a generative artificial intelligence model, generate and output adaptive warnings to the user based on real-time risk and emotional evaluation, recognize user emotional state from facial image or voice data, record and save video data automatically upon accident detection, and securely store recorded data in a remote information storage device for managed third-party access as needed. This enables comprehensive detection of risks that take user emotion into account, dynamic alert adaptation, and robust evidence management for insurance or legal procedures.

The term “driving apparatus” refers to a vehicle or transportation device that is operated by a user, such as an electric kickboard, scooter, or similar personal mobility equipment.

The term “information acquisition unit” refers to a component or set of components, such as sensors, cameras, or terminals, that are fixed to the driving apparatus and are configured to capture various types of data from the surrounding environment and from the user.

The term “analysis unit” refers to a processing component or software module that analyzes acquired information, including distance, velocity, the presence of objects, and the user's emotional state, using computational methods.

The term “user emotional state” refers to the psychological or physiological condition of the user, such as stress, attentiveness, or distraction, as determined from biometric or behavioral data.

The term “warning output unit” refers to a component or module that delivers alerts to the user, which may take the form of visual, audio, or tactile notifications in response to detected risks.

The term “recording and saving unit” refers to a system or mechanism that initiates the automated recording of video data and stores such data in case of accident detection.

The term “external storage area” refers to a memory location outside of the driving apparatus, such as a remote server or cloud storage, used for saving digital data.

The term “emotion recognition unit” refers to a component or software module configured to determine the user's emotional or mental state by analyzing facial images, voice data, or other biometric information.

The term “generative artificial intelligence model” refers to a computational model employing machine learning or deep learning techniques, and capable of interpreting complex data to perform tasks such as object detection, risk analysis, and emotion assessment.

The term “remote information storage device” refers to an external digital data repository accessible over a network, such as a server or cloud-based storage system, which stores recorded information data and manages access to third parties.

The term “third party” refers to any entity or person other than the user or system operator, such as insurance agencies, legal authorities, or relevant organizations, who may be authorized to access stored data in accordance with predetermined rules.

The present invention can be practically implemented by integrating a processor-equipped server, one or more terminals such as mobile information terminals, and driving apparatuses such as electric kickboards.

The terminal is mounted on the driving apparatus and is equipped with a camera, GPS module, accelerometer, microphone, and display. It functions as the information acquisition unit and the warning output unit. The terminal uses the camera to acquire video data of the surroundings, the GPS module to obtain location information, the accelerometer to detect speed and impacts, the microphone to collect user voice data, and the display and speakers to output warnings and alerts to the user. The terminal may use typical hardware such as a commercially available smartphone, and may run the Android or iOS operating system. Software libraries such as the Camera2 API for image acquisition, LocationManager for GPS, sensor APIs for accelerometer readings, and speech recognition APIs for voice input can be utilized.

The terminal preprocesses and formats the acquired information and transmits it to the server at predetermined intervals using wireless communication, such as 4G, LTE, 5G, or Wi-Fi, employing network protocols such as HTTPS. The terminal can also perform preliminary emotion recognition using facial recognition software libraries such as OpenCV and speech-to-text APIs.

The server is configured as the core processor and analysis unit. The server receives the information sent from the terminal, including video data, spatial data, and user biometric information. The server uses software frameworks and libraries such as TensorFlow or PyTorch to execute generative artificial intelligence models for high-level data processing and analysis. For example, the server can detect objects and measure distances in images using object detection models, calculate potential collision risks by evaluating relative velocities and positions, and assess the user's emotional state using pre-trained neural networks for facial and voice emotion recognition.

According to the risk assessment and the user's emotional state, the server determines whether to generate an alert and what the intensity and content of that alert should be. This information is sent back to the terminal, which then delivers adaptive warnings to the user through the display, speaker, or vibration motor.

If an accident is detected, for example, when the terminal's accelerometer senses a force above a certain threshold, the terminal automatically initiates video recording, capturing images before and after the impact event. The recorded data is then uploaded to the server for secure storage. The server stores evidence on a remote information storage device, such as a cloud storage service, using access controls for third-party retrieval in insurance or legal contexts.

A concrete example is as follows: The user mounts a smartphone on an electric kickboard and starts the safety application. The terminal collects video, speed, and facial and voice data while the user is riding. When a pedestrian is detected 1.8 meters ahead and the user's stress level is recognized as high, the server determines a high collision risk and instructs the terminal to issue a loud visual and audible warning. If an accident is detected, the terminal records a buffered segment of the video and uploads it for cloud storage. Insurance agents or authorized personnel can later be permitted secure access to the stored information as needed.

An example prompt sentence for a generative AI model that can be used in this system is as follows:

“Describe, step-by-step and with specific actions and data flow, how an electric kickboard safety system works using a terminal, server, and user-covering sensor activation, AI-based risk evaluation, alerting, accident detection, and evidence storage.”

The above configuration enables a practical, scalable, and reliable approach for implementing a user-adaptive vehicle safety system that makes effective use of sensor integration, wireless communication, machine learning, and cloud-based evidence management.

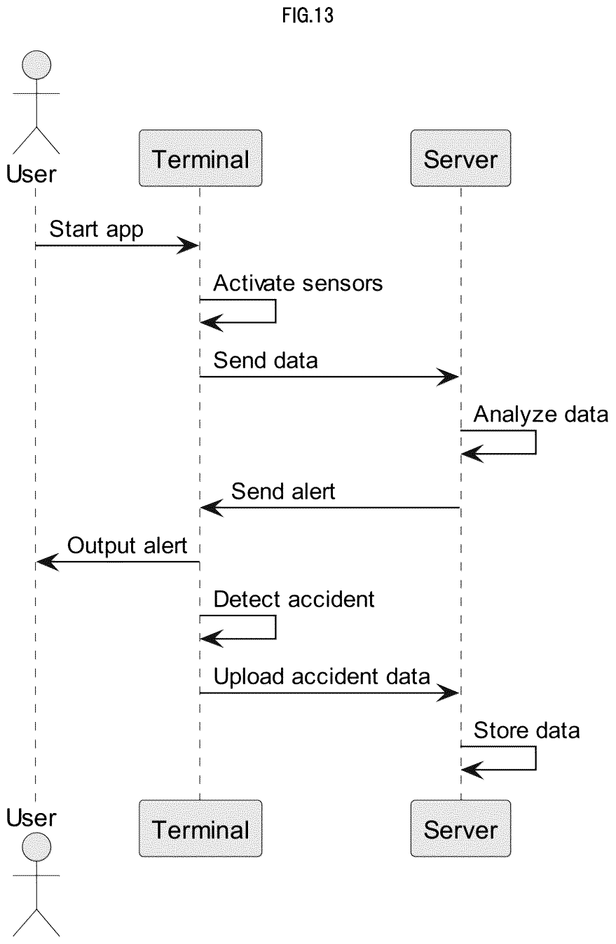

The following describes the processing flow using FIG. 13.

### Step 1:

The user mounts the terminal, such as a smartphone, onto the driving apparatus and starts the safety application.

Input: The terminal receives the user's action to start the application.

Processing: The terminal launches the dedicated app and initializes relevant sensors and hardware.

Output: The terminal is ready for data acquisition and monitoring.

### Step 2:

The terminal activates the camera, GPS module, accelerometer, microphone, and display for data collection.

Input: Sensor hardware is initialized via system APIs.

Processing: The terminal establishes streams from each sensor and prepares to capture video, audio, spatial data, and accelerometer readings in real time.

Output: Continuous flows of raw sensor data (video frames, audio samples, location, velocity, and acceleration values) are made available for processing.

### Step 3:

The terminal captures, preprocesses, and packages environmental data and user biometric data.

Input: Raw video frames, GPS coordinates, acceleration readings, facial images, and voice data.

Processing: The terminal compresses video frames, extracts facial features using a facial recognition library, processes audio via a speech-to-text API, filters sensor noise, and aggregates data into a structured format (such as a JSON payload).

Output: A packaged data payload containing environmental and biometric information.

### Step 4:

The terminal transmits the structured data payload to the server over a wireless network.

Input: Data payload prepared by the terminal.

Processing: The terminal establishes an HTTPS connection with the server and uploads the payload at set intervals (e.g., once per second).

Output: The server receives environmental, behavioral, and biometric data from the terminal.

### Step 5:

The server analyzes received data using computer vision and machine learning models.

Input: The server receives sensor and image data, facial feature vectors, and audio analysis results.

Processing: The server executes object detection models (e.g., using a generative AI model implemented in TensorFlow), calculates the distance to detected objects, evaluates relative speeds, and assesses collision risks. The server also evaluates emotion states using pre-trained facial and voice emotion recognition neural networks.

Output: The server generates a risk assessment score and an evaluation of the user's current emotional state.

### Step 6:

The server determines whether to generate an alert for the user and selects the appropriate alert modality and intensity.

Input: Risk assessment score and user emotional state.

Processing: The server applies threshold criteria to evaluate risk levels and adjusts the alert strength according to the user's stress or attentional status.

Output: An alert signal containing instructions for the type, content, and intensity of the warning to be delivered.

### Step 7:

The terminal receives the alert signal and provides adaptive feedback to the user via the output interface.

Input: Alert signal from the server.

Processing: The terminal decodes the alert, then displays a visual message, produces an audible warning through the speaker, and/or activates the vibration motor as instructed by the alert parameters.

Output: The user receives a real-time warning, such as a loud beep, full-screen visual cue, or phone vibration.

### Step 8:

The terminal monitors for accident events by evaluating accelerometer and gyroscope data in real time.

Input: Continuous accelerometer and gyroscope sensor data.

Processing: The terminal applies a threshold detection algorithm to identify sudden impacts or strong forces that may indicate a collision event.

Output: On detecting an accident, the terminal triggers the accident mode.

### Step 9:

The terminal records and saves video data from immediately before and after the detected accident event.

Input: Pre- and post-impact video buffer, accident event trigger.

Processing: The terminal saves a segment of buffered video data (for example, 30 seconds before and several minutes after the impact) to local storage.

Output: Video files and relevant sensor data associated with the accident are saved for subsequent upload.

### Step 10:

The terminal uploads accident video and metadata to the server for secure, remote storage.

Input: Recorded video and metadata from the terminal.

Processing: The terminal initiates an HTTPS or cloud API transfer to the server or external storage.

Output: The server receives and securely preserves accident evidence.

### Step 11:

The server manages storage of the uploaded accident evidence and controls access according to predetermined rules.

Input: Uploaded accident video and related metadata.

Processing: The server registers, indexes, and stores the evidence in secure, remote storage, such as a cloud repository. The server assigns access permissions for authorized third parties, e.g., for insurance or legal review.

Output: Accident data is securely stored and can be accessed by permitted parties as required.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

There is a need for a system capable of enhancing safety in a movable body by accurately monitoring both the surrounding environment and the operator's condition in real time. Existing technologies often lack the ability to comprehensively analyze environmental and operator information in an integrated manner; in particular, they are insufficient for evaluating the immediate risk of collision in connection with the operator's current emotional or cognitive state, and for dynamically adapting warning modes according to risk level. Furthermore, these technologies may not provide efficient recording and storage of critical data in the event of an incident for later use.

The specific processing by the specific processing unit 290 of the data processing device 12 in Application Example 2 is realized by the following means.

The present invention provides a server comprising a processor configured to acquire and preprocess environmental image and audio information, analyze such information with a generative artificial intelligence model to detect objects and measure distances, evaluate an operator's emotional state from face or voice information, generate and issue variable-intensity multimodal warnings according to combined risk assessment, and automatically record and store media upon detection of impact or sudden stop. This enables real-time, comprehensive safety monitoring, adaptive alerting, and efficient incident data management to enhance safety and post-incident analysis in a movable body.

The term “information acquisition device” refers to an apparatus or system component mounted on a movable body, such as a vehicle, that obtains environmental data including image information, audio information, or other sensor data relevant to the operation and surroundings. The term “processor” refers to an information processing unit capable of executing instructions for analyzing, evaluating, and controlling various functions within the system, including data acquisition, preprocessing, analysis, warning generation, and data recording.

The term “environmental information” refers to data concerning the surroundings of a movable body, including but not limited to image information, audio information, and measurement data acquired by sensors.

The term “preprocessing function” refers to processes performed on raw data such as image or audio information for enhancement, noise reduction, normalization, or feature extraction, as a preparation step for further analysis by artificial intelligence models.

The term “generative artificial intelligence model” refers to an algorithm or computational model, typically based on machine learning or neural networks, which analyzes preprocessed data to detect objects, estimate positions, measure distances, and generate information relevant to the operational environment.

The term “operator information acquisition unit” refers to a device or module that captures data related to the operator of the movable body, such as face images or voice recordings.

The term “emotion recognition function” refers to a software or algorithmic capability that analyzes face or voice information of the operator to determine or classify the operator's emotional or cognitive state.

The term “warning signal” refers to an electronic or physical signal generated to alert the operator of detected risks, which may be delivered via visual, auditory, or tactile modalities.

The term “external storage device” refers to any physical or network-connected memory apparatus used to store recorded data, including local memory devices or remote/cloud-based storage systems.

The term “movable body” refers to any apparatus or vehicle capable of movement, including, but not limited to, automobiles, ships, aircraft, or robots.

In order to embody the invention described in the claims, the following system configuration and operational workflow are provided.

The terminal, which may be a portable information terminal such as a smartphone or tablet, is mounted on a movable body such as a vehicle. The terminal is equipped with at least one image capturing device (such as a high-resolution camera module), a sound collection device (such as a digital microphone), motion sensors (such as accelerometers and gyroscopes), a display, a speaker, and a communication module (such as an LTE or Wi-Fi interface). The terminal also contains a user interface to allow the user to interact with the application.

The terminal is configured to continuously capture environmental image data from outside and inside the vehicle, as well as to collect audio data and sensor data relevant to the vehicle's movement (for example, acceleration or sudden impact).

The terminal transmits the collected image, audio, and sensor data in real time to the server using wireless communication. The server comprises a processor with sufficient computing power (such as a general-purpose processor, GPU, or cloud computing resource) and appropriate software resources. The main software components running on the server may include image processing libraries (such as OpenCV), machine learning and neural network frameworks (such as TensorFlow and PyTorch), a generative artificial intelligence model for object detection and risk assessment, emotional state analysis functions (such as dlib for face analysis and a pre-trained emotion recognition model for audio and facial data), and data storage management systems (for example, a database or cloud storage API).

The server preprocesses the incoming environmental data, applying noise reduction, normalization, and any necessary corrections to the media. Then, the generative AI model analyzes the preprocessed images to detect relevant objects (pedestrians, vehicles, obstacles, etc.), calculate their relative positions and distances, and estimate their speeds. Simultaneously, the server analyzes the operator's face and/or voice information-sent from the terminal-using the emotion recognition function to classify the operator's current emotional state (such as focused, distracted, stressed, or drowsy).

Based on both the environmental analysis and the emotional assessment of the operator, the server computes a risk score. If a threshold is exceeded, the server generates a warning signal detailing the warning modality, intensity, and frequency. The warning signal is sent back to the terminal, which then issues a visual, auditory, or tactile alert to the operator. For visual alerts, the terminal may display a vivid color warning on the screen; for auditory alerts, the speaker may use a text-to-speech engine to announce a caution message; for tactile alerts, a vibration motor may be activated.

If the terminal's motion sensors detect a collision, sudden stop, or abnormal event, the terminal immediately initiates video and audio recording. The recorded data is stored on a cloud-based external storage service, accessible for later review, evidence preservation, or insurance processing.

As an example, the user mounts the terminal on the dashboard and starts the safety-monitoring application. The terminal's camera streams both the road view and the driver's face to the server, and the microphone captures in-cabin sounds. When the generative AI model on the server detects a pedestrian within one meter ahead of the vehicle while also determining that the driver is under stress, a strong alert is triggered. The terminal displays a bright warning and loudly announces, “Danger! Pedestrian ahead!” through its speaker, while also vibrating for tactile emphasis. In the event of an actual collision, the video before and after the incident is automatically uploaded to cloud storage.

The system is highly adaptable. For example, the server can adjust its alert threshold or behavior in response to a prompt sentence input by the user or developer. Example prompt sentence: “If a pedestrian appears within one meter in front, issue an urgent alert that considers my current stress level.”

This enables dynamic, real-time integrated safety management based on both environmental data and human factors.

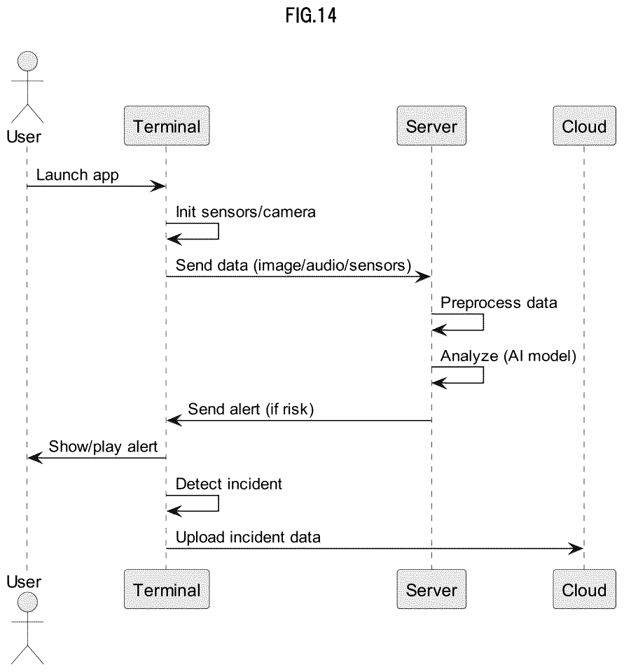

The following describes the processing flow using FIG. 14.

### Step 1:

Terminal activates the camera, microphone, and motion sensors when the application is launched.

Input: User launches the application; initial hardware state.

Processing: Terminal initializes the hardware components, prepares for data acquisition, and verifies network connectivity.

Output: Ready state for real-time data acquisition.

### Step 2:

Terminal captures real-time image, audio, and sensor data.

Input: Visual scenes from the vehicle interior and exterior, in-cabin audio, and movement sensor data.

Processing: Terminal continuously acquires frames from the camera, records sound, and periodically samples acceleration and shock data.

Output: Streams of image data, audio data, and sensor data in segmented packets.

### Step 3:

Terminal transmits captured media and sensor data to the server over a wireless network.

Input: Image, audio, and sensor data packets.

Processing: Terminal encodes and compresses the collected data, establishes a secure connection, and transmits the packets to the server via Wi-Fi or mobile data.

Output: Data packets successfully received by the server.

### Step 4:

Server preprocesses received data for analysis.

Input: Data packets containing image frames, audio samples, and sensor values from the terminal.

Processing: Server applies preprocessing algorithms such as normalization, noise reduction, frame resizing, and data validation using image/audio processing libraries.

Output: Clean and normalized data ready for AI analysis.

### Step 5:

Server analyzes preprocessed image data using a generative AI model for object and distance detection.

Input: Preprocessed image data.

Processing: Server feeds the image data into the generative AI model, which detects objects (such as pedestrians, vehicles, obstacles), computes their positions and distances relative to the movable body, and estimates their velocities.

Output: Metadata including recognized objects, their positions, relative distances, and speed estimations.

### Step 6:

Terminal collects and sends operator (driver) face and voice data to the server.

Input: Real-time face images and audio clips of the driver.

Processing: Terminal intermittently captures the operator's face image and voice, encodes, and securely transmits it to the server for emotional analysis.

Output: Operator biometrics received by the server.

### Step 7:

Server analyzes operator data for emotional state assessment.

Input: Face images and voice samples of the operator.

Processing: Server utilizes an emotion recognition model to extract facial and audio features, performs classification, and determines the operator's emotional or cognitive state (such as alert, stressed, drowsy).

Output: Emotional state metadata for the operator.

### Step 8:

Server combines environmental and operator state information to evaluate the risk score.

Input: Metadata regarding object positions/distances and operator emotional state.

Processing: Server independently or through a rule-based or AI-based risk assessment module calculates a comprehensive risk score, factoring in proximity of detected objects and current operator status.

Output: Risk evaluation result and recommended alert level.

### Step 9:

Server generates and transmits a warning signal to the terminal if a risk threshold is exceeded.

Input: Risk evaluation result and alert modality recommendations.

Processing: Server composes warning instructions, including the modality (visual, auditory, or tactile) and intensity/frequency, and sends them to the terminal.

Output: Warning signal packet received by the terminal.

### Step 10:

Terminal delivers the alert to the operator.

Input: Warning signal packet.

Processing: Terminal displays a warning message on the screen, uses the speaker for a synthesized voice alert, and activates the vibration motor for a tactile warning, with strength and frequency adjusted according to server's instructions.

Output: Multimodal alert experienced by the operator.

### Step 11:

Terminal detects abnormal events (collision or sudden stop) using sensor data.

Input: Continuous sensor data from accelerometer and shock detectors.

Processing: Terminal analyzes sensor values in real time to identify abnormal patterns, such as sudden high acceleration/deceleration indicating an incident.

Output: Detection of an abnormal event triggers emergency routines.

### Step 12:

Terminal records image and audio data upon incident detection and uploads it to cloud storage.

Input: Detection of an abnormal event, current and buffered media data.

Processing: Terminal immediately stores pre-incident and post-incident video and audio footage, and initiates an upload to an external cloud storage service, attaching time, location, and event metadata.

Output: Critical incident data securely stored in cloud storage for later retrieval.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

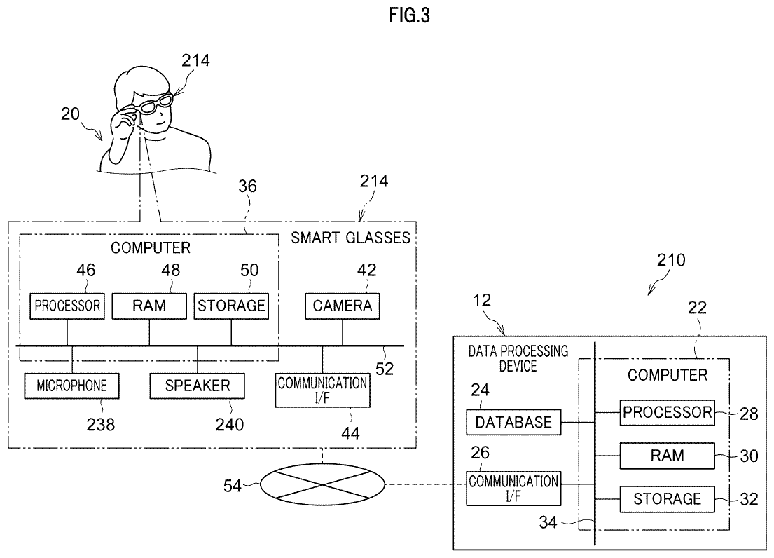

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

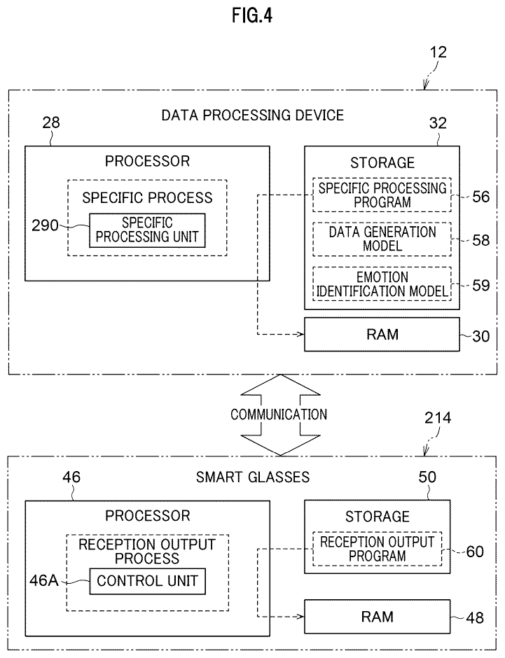

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

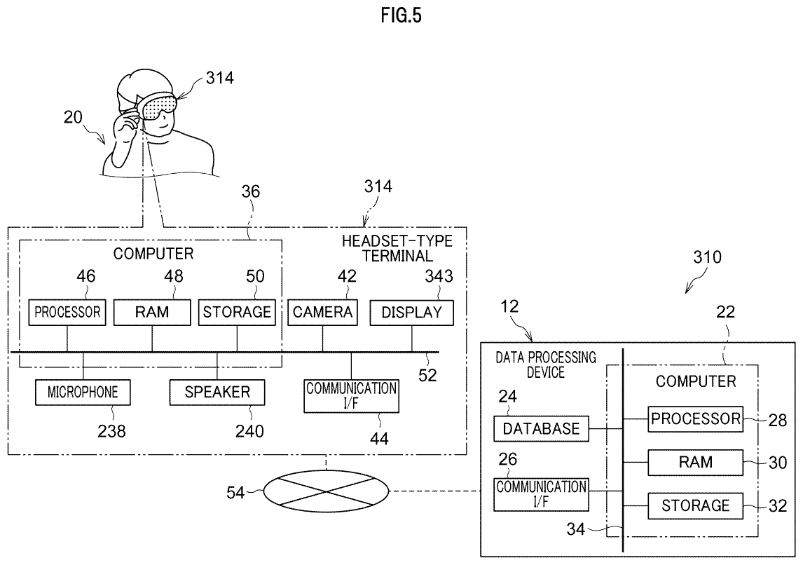

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

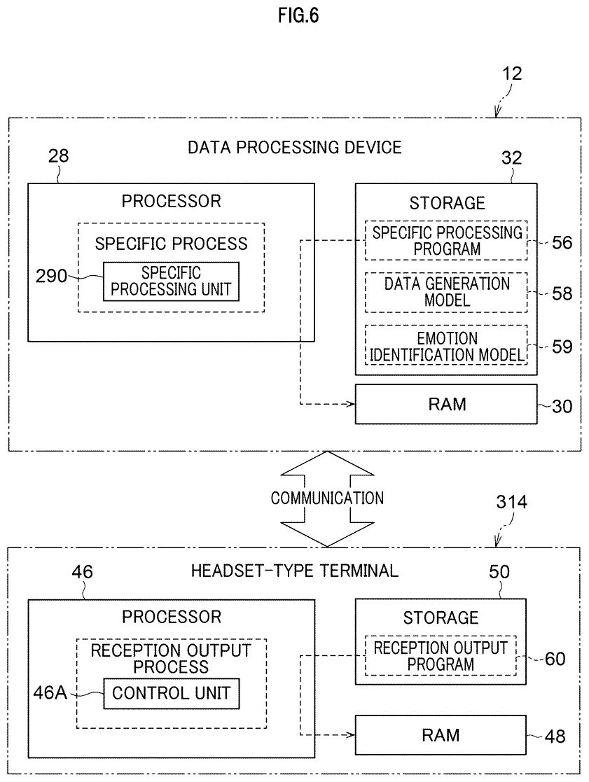

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

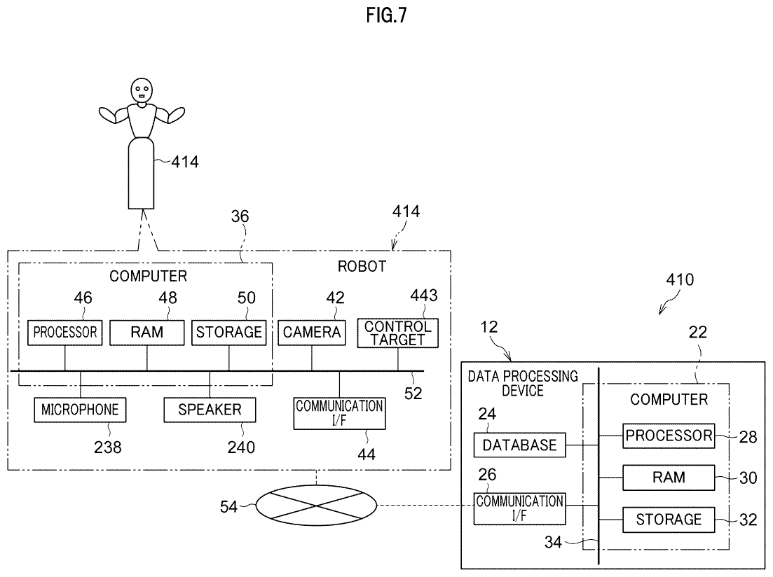

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

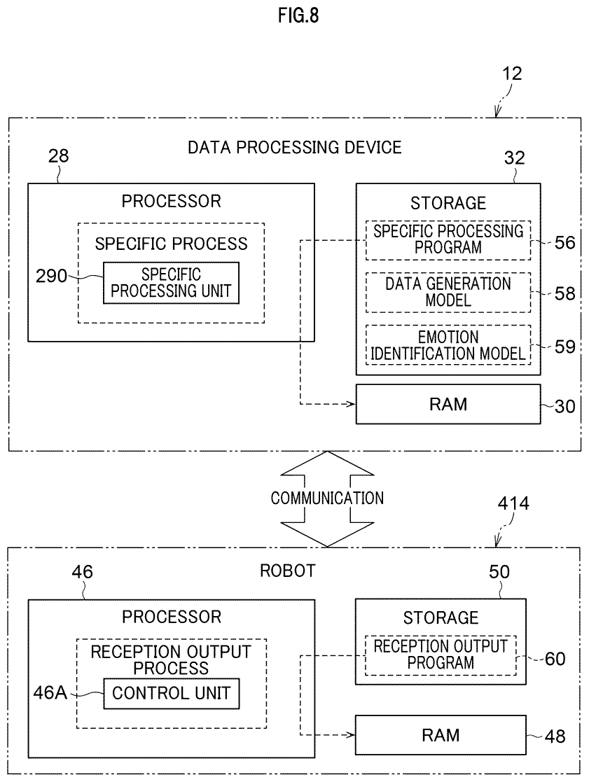

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

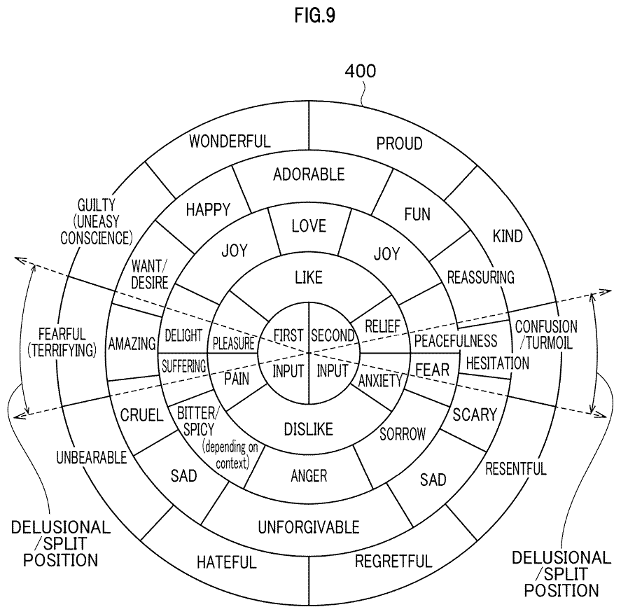

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center.

Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

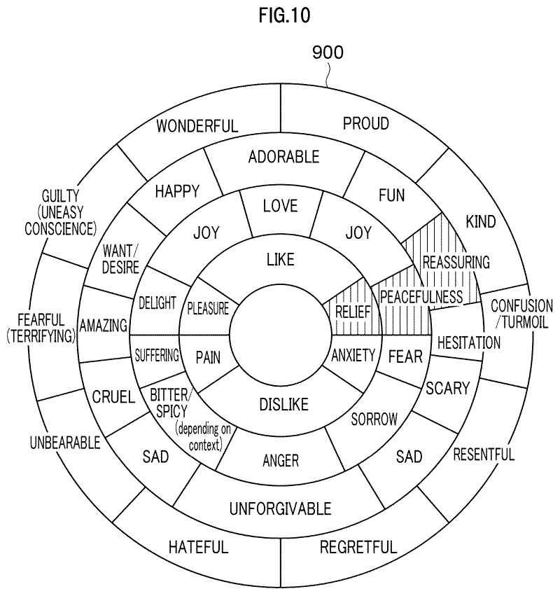

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
obtain environmental information from an information acquisition unit mounted on a transportation apparatus,
transmit image information and operation information acquired by the information acquisition unit to an external processing device via a communication network,
analyze the received image information and operation information at the external processing device using an artificial intelligence-based analysis unit to detect target objects and calculate distances,
evaluate contact risk based on the analysis result and operation information using a risk determination unit and generate an alert signal when the evaluated risk exceeds a predetermined threshold,
notify a user by visual, auditory, or tactile means when the alert signal is received,
and execute an automatic recording process upon detection of impact information, transmit the recorded information to the external processing device, and store the information in an external storage area.

### (Supplementary 2)

The system according to supplementary 1,
wherein the processor is configured to
implement the information acquisition unit by a communication terminal mounted on the transportation apparatus.

### (Supplementary 3)

The system according to supplementary 1,
wherein the processor is configured to
include, in the artificial intelligence-based analysis unit, a deep learning model that performs object identification and distance calculation.

### Application Example 1

### (Supplementary 1)

A system comprising a processor,
wherein the processor is configured to
acquire image information and physical information by an image information acquisition device installed on a vehicle,
analyze the acquired image information and physical information using an information analysis apparatus,
generate a collision risk assessment and estimate an operator emotional state based on the analysis,
notify the operator with an alert according to the collision risk assessment and the estimated emotional state by an alert control apparatus,
record captured and acquired information dynamically to a memory device upon occurrence of a specific event,
and execute a generative information processing model using computational resources to simultaneously analyze image information, physical information, and emotional state, and adaptively provide information to the operator.

### (Supplementary 2)

The system according to supplementary 1,
wherein the processor is configured to
operate the image information acquisition device as a portable information processing device attached to the vehicle.

### (Supplementary 3)

The system according to supplementary 1,
wherein the processor is configured to
estimate spatial distances to other moving objects and to objects in the travel space, and simultaneously estimate the operator's emotional state using an information processing model.

### Example 2

### (Supplementary 1)

A system comprising a processor,
wherein the processor is configured to
acquire various types of information related to a surrounding environment by means of an information acquisition unit that is fixed to a driving apparatus,
analyze the acquired information data, including object distance, velocity information, and a user emotional state, using an analysis unit,
evaluate the surrounding risk and the user emotional state based on the analysis, output a warning to a user according to the evaluated risk and emotional state by means of a warning output unit,
automatically record video data in response to detection of an accident and store the recorded data in an external storage area by means of a recording and saving unit,
recognize the user emotional state from facial image data or audio data acquired from the user, and adjust the content or frequency of the warning according to the recognized emotional state by means of an emotion recognition unit,
perform information data analysis using a generative artificial intelligence model that employs machine learning or deep learning,
store recorded data in a remote information storage device via a network and manage provision of said data to a third party as needed.

### (Supplementary 2)

The system according to supplementary 1,
wherein the processor is configured to
cause the information acquisition unit to include a mobile information terminal installed in the driving apparatus.

### (Supplementary 3)

The system according to supplementary 1,
wherein the processor is configured to
perform object recognition, distance measurement, risk evaluation, and emotion evaluation using the generative artificial intelligence model in the analysis unit.

### Application Example 2

### (Supplementary 1)

A system comprising a processor,
wherein the processor is configured to
acquire environmental information obtained by an information acquisition device mounted on a movable body,
preprocess image information or audio information included in the environmental information through a preprocessing function,
analyze the preprocessed image information using a generative artificial intelligence model to calculate object position information and distance information,
analyze face information or audio information of an operator obtained by an operator information acquisition unit using an emotion recognition function to evaluate an emotional state of the operator,
generate a warning signal based on analysis results of both the environmental analysis and operator state evaluation, and issue a visual, auditory, or tactile warning with variable intensity or frequency to the operator,
and, when impact or sudden stop is detected by an acceleration detection device, automatically start recording image and audio information and store the recorded information in an external storage device or a storage area on a network.

### (Supplementary 2)

The system according to supplementary 1,
wherein the information acquisition device is a portable information terminal mounted on the movable body.

### (Supplementary 3)

The system according to supplementary 1,
wherein the processor is configured to perform risk evaluation based on calculated object distance information and speed information by the generative artificial intelligence model, in combination with operator state analysis results.

What is claimed is:

1. A system comprising a processor,
wherein the processor is configured to:
acquire image data by an image acquisition unit fixed to a driving apparatus,
analyze the acquired image data,
issue an alert to a driver based on the analyzed data, and
automatically record and save data in the event of an accident.

2. The system of claim 1, wherein the image acquisition unit is a mobile terminal fixed to the driving apparatus.

3. The system of claim 1, wherein the analyzing comprises analyzing inter-vehicle distance, distance to a person, and distance to an object using an AI model.
